(19) United States
(12) Patent Application Publication
(10) Pub. No.: US 2016/0124521 A1
(43) Pub. Date: May 5, 2016

(54) REMOTE CUSTOMIZATION OF SENSOR SYSTEM PERFORMANCE

(71) Applicant: FREESCALE SEMICONDUCTOR, INC., Austin, TX (US)

(72) Inventor: David A. Hayner, Austin, TX (US)

(21) Appl. No.: 14/529,296

(22) Filed: Oct. 31, 2014

(51) Int. Cl. G06F 3/0346; H04L 29/06; H04L 29/08; G06F 3/041

(52) U.S. Cl. CPC G06F 3/0346; G06F 3/041; H04L 67/42; H04L 67/1097

(57) ABSTRACT

A mechanism is provided to customize response of devices to inputs received by a variety of sensors on those devices. Data samples of a desired input event are gathered and then those data samples are transmitted to a remote server computer for analysis. The analysis provided by the remote server computer results in a unique “signature” for the desired input event. This signature is then transmitted back to the device, which then stores the signature for use in subsequent input event analysis by the device. In this manner, the device can be customized to interpret a particular input provided by a particular user in order to elicit a specified response by the device.

### BACKGROUND

1. Field

This disclosure relates generally to sensor devices in hand held devices, and more specifically, to off-loading analysis processing of sensor data to a remote computing node to provide signatures usable in recognition of future sensor data.

2. Related Art

Modern consumer devices, such as smart phones, game controllers, and the like, can be configured to interpret a variety of gestures or other inputs as commands. For example, a tap or a shake of the device can be used to elicit a programmed response. Devices can use a variety of sensors to detect these types of inputs (e.g., inertial sensors to detect gesture inputs).

It is desirable to have a device that is capable of having customized input responses, either for specific tasks or for different users. In a variety of uses of sensors for collecting and analyzing input data, the processing methods used to analyze those inputs and data extracted from those inputs is a function of the application, use, environment, and other factors. In many cases, the amount of signal processing required to customize or adapt local interpretation of this data is impractical in a low-power, low-cost device. It is therefore desirable to utilize alternate computing resources to reduce the amount of localized processing by a consumer device needed to interpret gestures for customized local response.

### BRIEF DESCRIPTION OF THE DRAWINGS

The present invention may be better understood, and its numerous objects, features, and advantages made apparent to those skilled in the art by referencing the accompanying drawings.

FIG. 1 is a simplified block diagram illustrating a system configured to implement embodiments of the present invention.

FIG. 2 is a simplified block diagram illustrating a sensor data path, usable by embodiments of the present invention.

FIG. 3 is a simplified flow diagram illustrating a process performed by a device in response to detecting a sensor event, in accord with embodiments of the present invention.

FIG. 4 is a simplified flow diagram illustrating one example of a process performed by a server in response to receiving an event data sample, in accord with embodiments of the present invention.

FIG. 5 depicts a block diagram of a computer system suitable for implementing aspects of the present invention.

FIG. 6 is a block diagram depicting a network architecture suitable for implementing aspects of the present invention.

The use of the same reference symbols in different drawings indicates identical items unless otherwise noted. Figures are not necessarily drawn to scale.

### DETAILED DESCRIPTION

A mechanism is provided to customize response of devices to inputs received by a variety of sensors on those devices. Data samples of a desired input event are gathered and then those data samples are transmitted to a remote server computer for analysis. The analysis provided by the remote server computer results in a unique “signature” for the desired input event. This signature is then transmitted back to the device, which then stores the signature for use in subsequent input event analysis by the device. In this manner, the device can be customized to interpret a particular input provided by a particular user in order to elicit a specified response by the device.

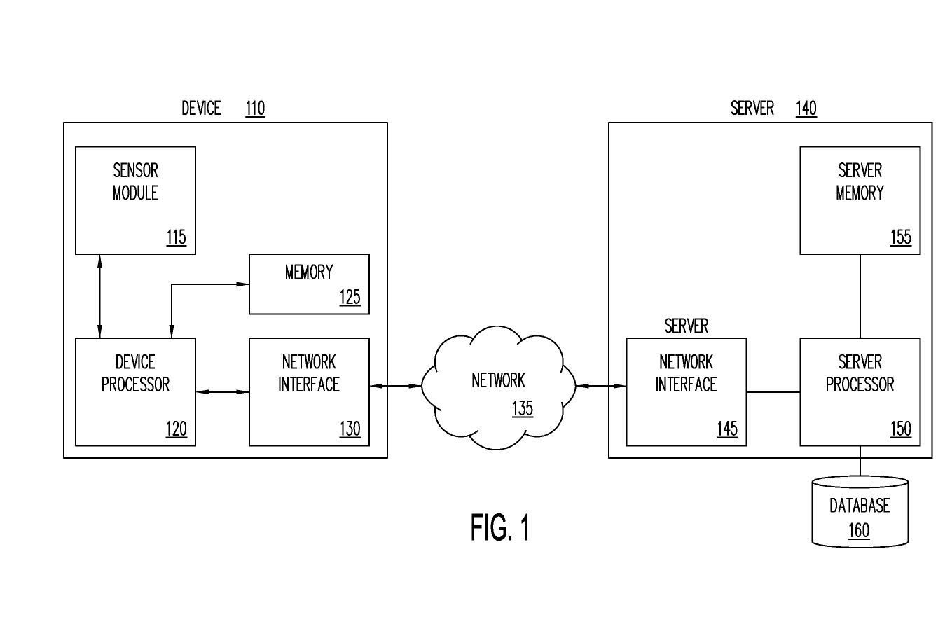

FIG. 1 is a simplified block diagram illustrating a system configured to implement embodiments of the present invention. Device 110 generally has limited computing resources to analyze and interpret inputs detected by a sensor module 115. Device 110 can be a consumer electronics device including, for example, a mobile phone, a smart phone, a tablet computing device, and the like. Sensor module 115 can include a variety of input event sensors, including, for example, accelerometers, gyroscope sensors, magnetic field sensors, audio sensors, and the like, in any combination. Such sensors can detect a variety of inputs, including, for example, device orientation changes, impacts on the device, and sounds.

Sensor module 115 is coupled to device processor 120, which is in turn coupled to a device memory 125. Device processor 120 is configured to receive signals generated by sensor module 115 and to analyze those signals to determine whether those signals are associated with a known event whose characteristics are stored in device memory 125. Upon finding a match to a known input, device processor 120 can execute a predetermined response. For example, if device 110 is a mobile phone and the phone is receiving a call, then a set of sensor signals corresponding to the phone being picked up and held to a users ear can result in a device response of accepting the call and activating the speaker and microphone of the phone to allow a conversation.

The event characteristics stored in device memory 125 can take the form of a set of “signatures” each related to a type of input event. These signatures can be either pre-configured (e.g., for general inputs having little differentiation from user to user, such as a tap or a shake) or customized using the mechanism described herein (e.g., for inputs that may have significant differentiation from user to user). A signature can include expected signal values generated by one or more sensors in response to an event (e.g., data values or slopes of changes to data values over time). Portions of the signals received from sensor module 115 are processed by device processor 120 in order to generate event signatures associated with the signal, which are compared against the stored set of signatures.

For customized responses, device 110 can be placed in a learning mode in order to receive and store a set of sample event data from which new signatures can be generated. For example, an application executing on device 110 may require a user to perform a physical handshake motion with the device. During setup of the application, the user can be asked to execute the handshake motion with the device several times in order to build up a sufficient event sample from which to generate a reliable signature for the handshake motion. During such a learning process, inertial sensors in sensor module 115 can generate signals associated with the handshake motion which can be stored in a device memory (e.g., memory 125). In some cases, however, device processor 120 will not have sufficient computing power to analyze the set of handshake sensor data in order to determine an appropriate set of characteristics from which to generate a signature of the handshake motion.

In order to analyze the sample event data for representative signatures, embodiments of the present invention transmit the event data, or information representing that data, to a remote server 140. Device processor 120 is coupled to a network interface 130, which is configured to transmit data over network 135 to remote server 140. In one example, network interface 130 can be a wireless broadband modem and transmitter and network 135 can be a cellular data network.

Server 140 can be, for example, one or more sets of computing resources operated by a provider of device 110, a provider of network services, or a third-party analysis provider. One characteristic of server 140 is that it includes significantly more processing resources than are present in device 110. The asymmetrical relationship between the processing resources of server 140 and device 110 enable the server to perform significantly more complex sensor data analysis than can be performed by device 110. This allows for device 110 to have a significantly lower cost and lower power processor. Further, the computing resources provided by server 140 can be used for analysis of data generated by many devices and by many providers of network services, enabling the costs of the server's computing resources to be distributed over many entities.

Server 140 is coupled to the network 135 by a server network interface 145. Server network interface 145 is coupled to server processor 150. Data received by server network interface 145 is provided to server processor 150, which stores that data in a server memory 155. Sensor event data received from a device 110 includes information identifying the originating device, which is stored with the sensor event data so that results of the analysis can be provided back to the appropriate originating device.

Analysis of the sensor event data received from a device 110 can be performed by server 140 in a number of ways. In one embodiment, server 140 has a database 160 containing data sets associated with a variety of sensor events of interest. For example, an analysis of a large number of people performing a handshake gesture on devices similar to device 110 can be conducted. Sensor information associated with handshake gestures can include signals received from X-Y-Z accelerometers as well as three-axis gyroscopic sensors. Information in the data set from these sensors can be analyzed to determine time frames having common accelerations and angular changes present in typical handshakes. Server processor 150 can then analyze the sensor event data provided by device 110 for behaviors similar to that represented in the large data set, but with values unique to the analyzed event.

One way of performing such analysis is vector quantization of the sensor event data, using the characteristics related to a typical event (e.g., a handshake) as initial seed values, from which to determine specific values associated with the sensor event data at the times of interest. Since vector quantization is an iterative process, and since the process can involve multiple time slices of the sensor event, analysis of the sensor event data can consume a significant amount of computing resources. Further, since the process can involve use of a large data set for seed values, significant storage resources are used. Thus, it would be impractical to perform these computations on device 110 given the limited computing resources available.

Once the analysis is performed on the sensor event data, a unique set of event information is gathered for that user on that device. This unique set of event information is a “signature” for that event/user/device.

It is possible that the server will not arrive at a signature for the given sample of sensor event data. For example, since vector quantization arrives at centroids through an iterative process, if the data is not well clustered or if some of the data is bad, then the process may not arrive at a cluster centroid within a reasonable number of iterations. In an instance where a signature cannot be derived, server 140 can request additional sample data from device 110. The device then prompts the user to perform the event of interest again and provides that information back to the server. This new information can then be added to the previously provided sensor event data, or can replace the previously provided sensor event data, and additional signature generation analysis can be performed. The process of performing analysis, requesting additional data, generating additional data, and providing additional data back to the server can occur sequentially in near real time, or be performed over a period of time.

Once server 140 has generated a representative signature of the event, server 140 can then transmit the signature information back to device 110 through network 135. This new signature is stored by the device in device memory 125. Subsequently, when a sensor event occurs, information related to that event can be analyzed and compared to all signatures stored in device 110, including the new signature.

FIG. 1 illustrates device 110 having a separate sensor module, device processor, and device memory. It should be noted that embodiments of the present invention are not restricted to such a configuration. For example, sensor module 115 can include a dedicated processor configured to analyze information generated by the sensor module and can also include a signature memory for storing some or all signatures. In this manner, a central device processor can be relieved of processing associated with the bulk of sensor event data generation.

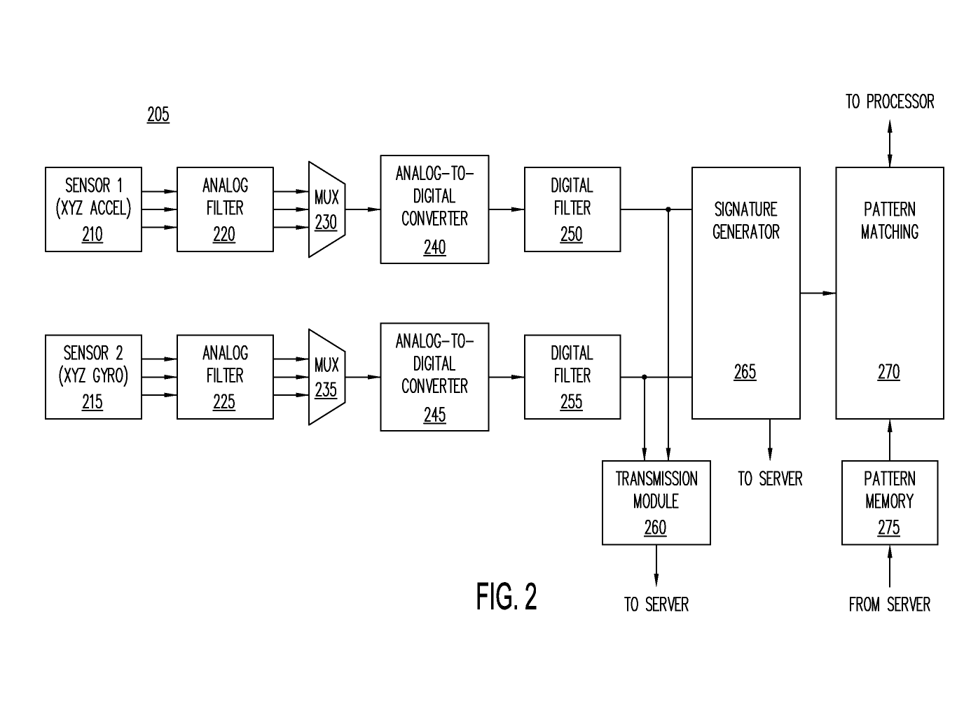

FIG. 2 is a simplified block diagram illustrating a sensor data path, usable by embodiments of the present invention. Data path 205 begins with sensors 210 and sensors 215. For example, sensors 210 can be a set of X-Y-Z accelerometers and sensors 215 can be a set of three-axis gyroscopes. It should be understood that device data path 205 is not limited to accelerometers and gyroscopes and can include other types of sensors (e.g., magnetometers and audio sensors). Sensors 210 and 215 provide analog data to analog filters 220 and 225, respectively. The analog filters can eliminate noise generated by the sensors. For example, if a set of sensors is expected to detect rapid movement and not gradual movement, then signals associated with gradual movement can be filtered out by the analog filter. As illustrated, three data paths lead from the sensors to the analog filters; these data paths represent data generated by each accelerometer or gyroscope in the sensor (e.g., an X-axis accelerometer, a Y-axis accelerometer and a Z-axis accelerometer). Size and frequency of signals generated by sensors 210 and 215 depend upon the nature of the sensors themselves. For example, a low resolution sensor can be an eight-bit accelerometer, while a high resolution sensor can be a 14-bit accelerometer. Frequency of a sensor is associated with the time sensitivity to change of that sensor. For example, accelerometer operating at a frequency of 500 Hz can detect more subtle changes in acceleration than can an accelerometer operating at a frequency of 300 Hz.

Once the sensor data has been filtered for noise, the data from the set of sensors can be combined using multiplexors 230 and 235 for each data path. The combined data can then be provided to an analog-to-digital converter 240 and 245, for each data path, in preparation for digital processing. Once converted to a digital signal, the sensor data can be subjected to additional digital filtering using digital filters 250 and 255 for each data path.

At this point, the filtered digital signals from the sensors can be transmitted to the server (e.g. 140) using a data transmission module 260. Data transmission module 260 can include, for example, network interface 130 as well as a buffer memory to queue the raw digital signals prior to transmission. Alternatively, data transmission module 260 can include a longer-term memory to store the raw digital signals until the device reaches a lull in other data transmission. As discussed above, when a device 110 is in learning mode, several iterations of a sensor event can be performed with data being transmitted to the server either after each event or after some or all of the events have been performed.

Transmitting raw data of sensor events to the server can provide a large amount of information to the server for processing and thereby capture all nuances detected by the sensors, but to do so can require significant bandwidth and time during which the network interface of the device is occupied. For example, typical set of sensor data for an event can include on an order of 60,000 bits (i.e., 60 bits per sample and 1000 samples per event). If the data analysis at the server requires 12 sets of sensor data related to an event, this can involve 720,000 bits of information to be sent to the server over the network. An alternative to transmitting the filtered event data can involve passing the data through a signature generator 265. Signature generator 265 can generate one or more signatures representing the sensor data and these signatures can then be provided to the server over the network. One advantage of providing the signatures rather than raw data is that signatures generated by signature generator 265 will later used during pattern matching. Thus, the server can perform its analysis using the same data that would be used for pattern matching. Further, the amount of data provided to the server is significantly less than the total amount of raw data. A disadvantage, however, is that the process of generating signatures makes the data provided to the server less complete.

When the device is not in learning mode (i.e., the device is determining the nature of the event), signature generator 265 passes the generated signatures to a pattern matching stage 270. Pattern matching stage 270 can be performed, for example, by device processor 120, a processor associated with sensor module 115, a processor specifically configured to perform pattern matching tasks, dedicated CMOS logic to implement neural nets, other hardware accelerators, or a combination thereof. One or more signatures associated with the sensor event, as generated by signature generator 265, are compared against signature patterns stored in pattern memory 275. Signatures stored in pattern memory 275 are those generated by server 140, as described above, or preconfigured patterns for generic events provided with the device. A number of processes can be used to perform the pattern matching. One embodiment of the present invention uses a mean square error calculation, which determines whether a stored pattern matches a pattern associated with the current event within preset bounds. If a matching pattern is found, device processor 120 is informed of the match and the device processor can perform tasks associated with the identified match. If no matching pattern is found, then either an error condition can be generated and the device can perform an appropriate task, or no task can be performed.

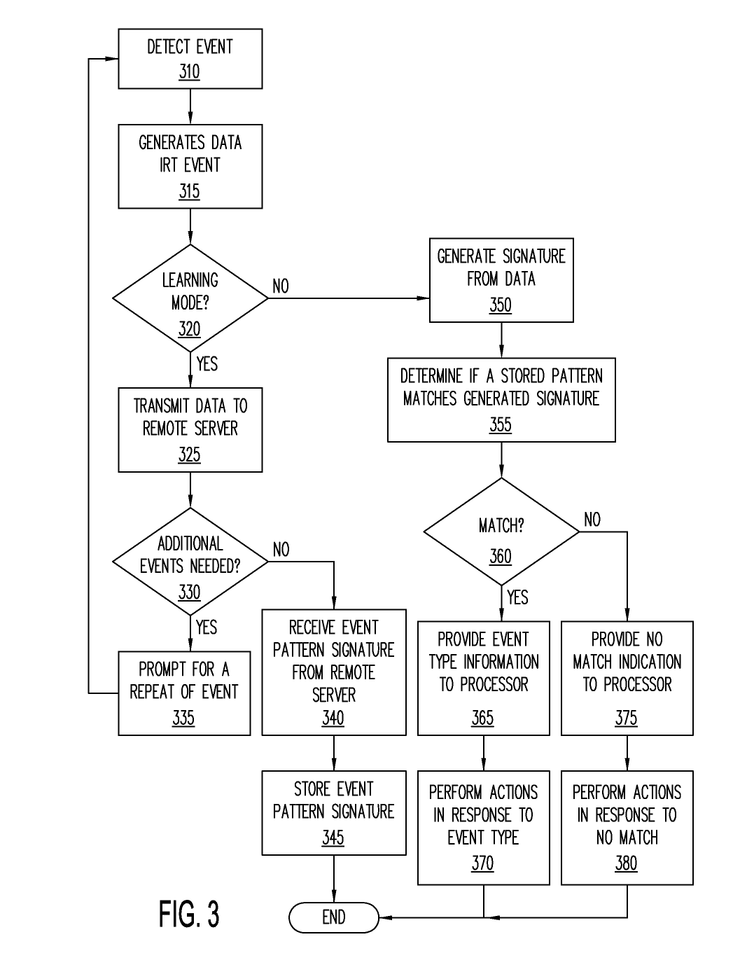

FIG. 3 is a simplified flow diagram illustrating a process performed by a device in response to detecting a sensor event, in accord with embodiments of the present invention. An event is detected by one or more sensors (e.g., sensors 210 and 215) (310). Data is then generated by the sensors in response to that event (315). As discussed above with regard to FIG. 2, this data can be a sampling of the characteristics of the sensor during the course of the event. The data can be filtered to reduce noise and can be converted from analog form to digital form.

A determination can then be made as to whether the device is in learning mode (320). If the device is in learning mode, that is, if the device is collecting data regarding a type of event for analysis, the data is transmitted to a remote server (325). As discussed above, the transmitted data can be the raw digitized event data, or can be signature data generated from the event. A determination can then be made as to whether additional event data is needed (330). Data collection for analysis can be performed as part of an initial setup procedure for an application executing on the device. Part of this procedure can include requiring a specified number of repetitions of the event. Determination event 330 can evaluate whether a requisite number of repetitions has been performed. If additional events are needed, then the device can prompt for a repeat of the event (335).

If no additional events are needed, then the device waits to receive an event pattern signature from the remote server (340). Once the device receives the event pattern signature, the event pattern signature is stored (345). The process of transmitting data to the remote server through receiving an event pattern signature from the remote server will not necessarily be performed in any immediate sequence to one another. That is, sensor event data can be buffered for later transmission from the device. Further, the remote server can perform its analysis over an extended period of time depending upon other processing needs associated with the server.

If the device is not in learning mode (320), then the device generates a signature from the event data (350). Pattern matching is then performed to determine if a stored pattern matches the generated signature (355). If a match is found among the stored patterns (360), then event type information is provided to the device processor (365). The device processor can then perform actions in response to the event type (370).

If no match is found among the stored patterns (360), then a no match indication can be provided to the processor (375). The processor can then perform appropriate actions in response to the no-match indication (380). Such actions can include, for example, providing an error indication to the user or simply doing nothing.

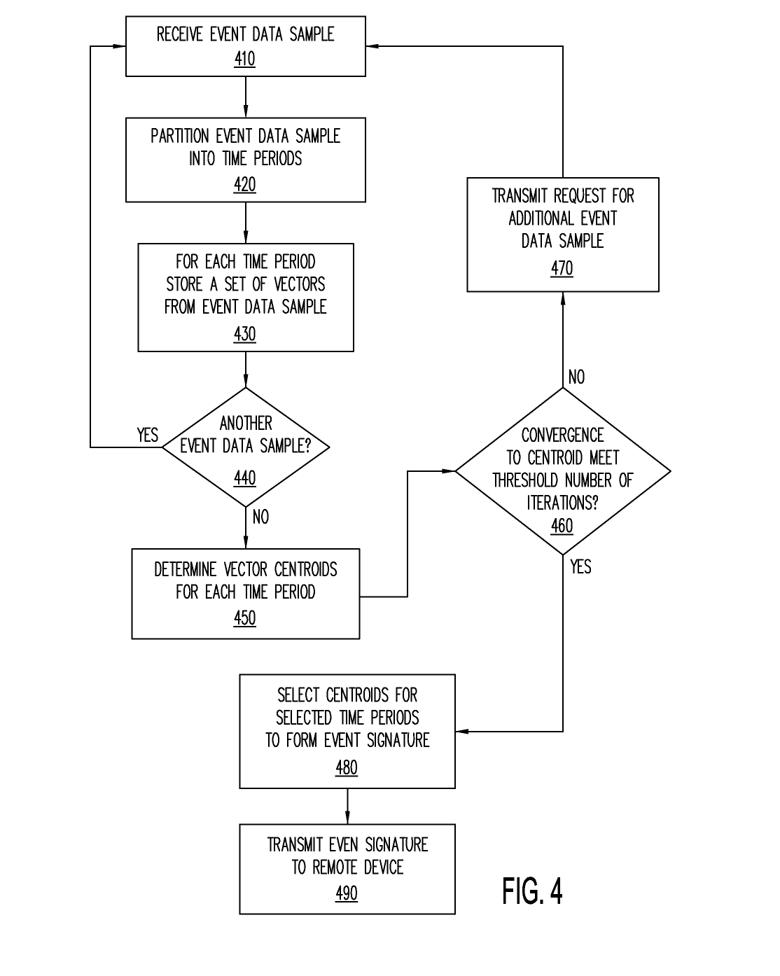

FIG. 4 is a simplified flow diagram illustrating one example of a process performed by a server in response to receiving an event data sample, in accord with embodiments of the present invention. The process begins with the server receiving an event data sample (410). As discussed above, the event sample can be received over a network from one or more devices 110. The event data sample can be partitioned into a number of time periods (420). For each time, a set of vectors can be stored from the event data sample (430). The time periods chosen can include particular time periods of interest determined from a stored data collection for anticipated associated motion. As discussed above, a server 140 can include a database 160 storing sets of historical event data. Previous analysis of the historical event data can reveal time periods of particular interest for a specified event. With this in mind, those same time periods can be used for partitioning the received data sample.

A determination can be made as to whether there is another event data sample for analysis (440) and if so then steps 410-430 are repeated. If no additional event samples are received, then analysis of the data samples is performed to determine vector centroids for each time period. As discussed above, one mechanism for determining vector centroids is through a vector quantization analysis. An initial seed centroid can be chosen from the historical event data, as discussed above. A determination can be made as to whether an appropriate convergence to a centroid has occurred under a threshold number of iterations (460). If no convergence has occurred, then the server can transmit a request for additional event data samples to the device (470). If convergence has occurred, then centroids can be selected from selected time periods to form an event signature (480). The compiled event signature is then transmitted to the remote device (490).

In the previously described embodiment, analysis of the sensor data is performed prior to use of an application that uses the signature data. Additional embodiments provide for periodic or continuous updating of the sensor event signatures over time. For example, a device can periodically store samples of sensor event data associated with an identifier for the event, during normal usage of the device. Once a predetermined number of events data is stored, it can be sent to the remote server (e.g., server 140) for analysis. In an alternate example, the device can send continuous updates of sensor event data to the remote server. The additional samples of sensor event data can be included in the original set for a new determination of signatures using the analysis methods discussed above. Alternatively, a signature update can be performed using the new data to modify the previously found signature vectors.

It will be appreciated that a method has been provided that includes generating data associated with a first sensor event where a hand-held device includes one or more sensors detecting the sensor event, transmitting the data to a remote computing node for analysis, determining whether additional sensor event data is required for the analysis, providing the additional sensor event data to the remote computing node in response to the determining, receiving event results of the analysis from the remote computing node, and storing the event result in an event data storage in association with an event type identifier.

In one aspect of the above embodiment, the method further includes generating data associated with a second sensor event, processing the data associated with the second sensor event, comparing the processed data with one or more event results stored in the event data storage, and performing one or more actions in response to the associated event type identifier if the processed data matches an event result. In a further aspect, an event result of the one or more event results includes a signature that includes characteristics of a type of sensor event associated with the event type identifier. In a still further aspect, processing the data associated with the second sensor event includes generating characteristics of the second sensor event for comparing against signatures stored in the event data storage. In another further aspect, the signature is generated by vector quantization analysis of the sensor event data as performed by the remote computing node. In another aspect, comparing the processed data with the one or more event results includes performing a means square error analysis.

Another embodiment of the present invention provides a hand-held apparatus that includes one or more sensor modules, a network interface coupled to a network, a memory, and processing circuitry coupled to the one or more sensor modules, the network interface, and the memory. The one or more sensor modules are configured to detect a first sensor event and generate data associated with the first sensor event. The processing circuitry is configured to: if the hand-held apparatus is currently in learning mode, provide the data associated with the first sensor event to the network interface for transmission to a remote computing node for analysis of sensor event characteristics, and display a request for a user of the hand-held apparatus to repeat an action associated with the sensor event if additional sensor event data is required for the analysis by the remote computing node; receive event results of the analysis from the remote computing node via the network interface; and, store the event results in the memory in association with an event type identifier.

One aspect of the above embodiment further includes the one or more sensor modules further configured to detect a second sensor event and generate data associated with the second sensor event, and the processing circuitry further configured to compare identifying characteristics of the second sensor event with one or more event results stored in the memory, and if the identifying characteristics of the second sensor event match an event result, perform one or more actions in response to the event type identifier associated with the matching event result. In a further aspect, the hand-held apparatus further includes a signature generator module configured to determine the identifying characteristics of the second sensor event. In a further aspect, a sensor module of the one or more sensor modules includes the signature generator. In another aspect, the processor includes the signature generator. In another aspect, the signature generator is further configured to determining identifying characteristics of the first sensor event, and the data associated with the first sensor event includes the identifying characteristics of the first sensor event.

In another aspect of the above embodiment, a sensor module of the one or more sensor modules further includes one or more sensors configured to generate raw data in response to the first sensor event, and one or more filters coupled to the one or more sensors and configured to filter noise signals from the raw data. In a further aspect the one or more sensors includes one or more of an accelerometer, a gyroscope, and an audio sensor. In another aspect of the above embodiment, the processor is further configured to perform the comparing of identifying characteristics using a mean square error calculation. In another aspect of the above embodiment, the hand-held apparatus includes one of a mobile phone, a smart phone, a tablet computing device, a portable game console, a remote control device, and a digital music player. In another aspect, the event results include characteristics of a type of event associated with the first sensor event, where the characteristics are generated by a vector quantization analysis of the sensor event data performed by the remote computing node.

Another embodiment of the present invention provides a non-transient computer-readable storage medium storing instructions executable by a processor of a hand-held computing device, the instructions configured to perform steps that include: transmitting data associated with a first sensor event to a remote computing node for analysis, wherein the hand-held computing device comprises one or more sensors detecting the sensor event; determining if additional sensor event data is required for the analysis; in response to said determining, repeating said transmitting and said determining; receiving event results of the analysis from the remote computing node; and storing the event results in an event data storage in association with an event type identifier. In one aspect of the above embodiment, the instructions are further executable to perform comparing data associated with a second sensor event with one or more event results stored in the event data storage; and if the data associated with the second sensor event matches an event result, performing one or more actions in response to the associated event type identifier. In a further aspect, the steps are further executable to include generating characteristics of the second sensor event for comparing against the one or more event results stored in the event data storage, wherein the one or more event results comprise characteristics of a type of event associated with the first sensor event, and the characteristics are generated by a vector quantization analysis of the sensor event data performed by the remote computing node.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of device data path 205 are circuitry located on a single integrated circuit or within a same device. Alternatively, device data path 205 may include any number of separate integrated circuits or separate devices interconnected with each other. For example, digital filters 250 and 255 may be located on a same integrated circuit as analog filters 220 and 225, respectively, or on a separate integrated circuit or located within another peripheral or slave discretely separate from other elements of device data path 205. Signature generator circuitry 265 and pattern matching circuitry 270 may also be located on separate integrated circuits or devices. Also for example, portions of device data path 205 may be soft or code representations of physical circuitry or of logical representations convertible into physical circuitry. As such, portions of device data path 205 may be embodied in a hardware description language of any appropriate type.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

### An Example Computing and Network Environment

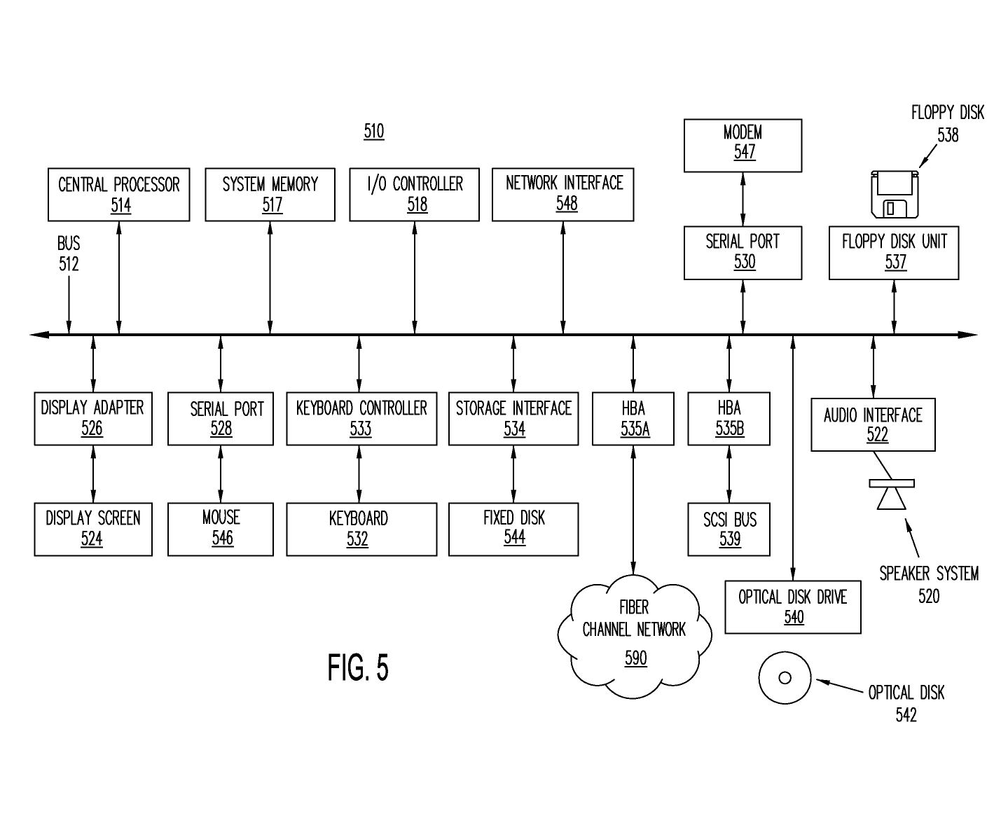

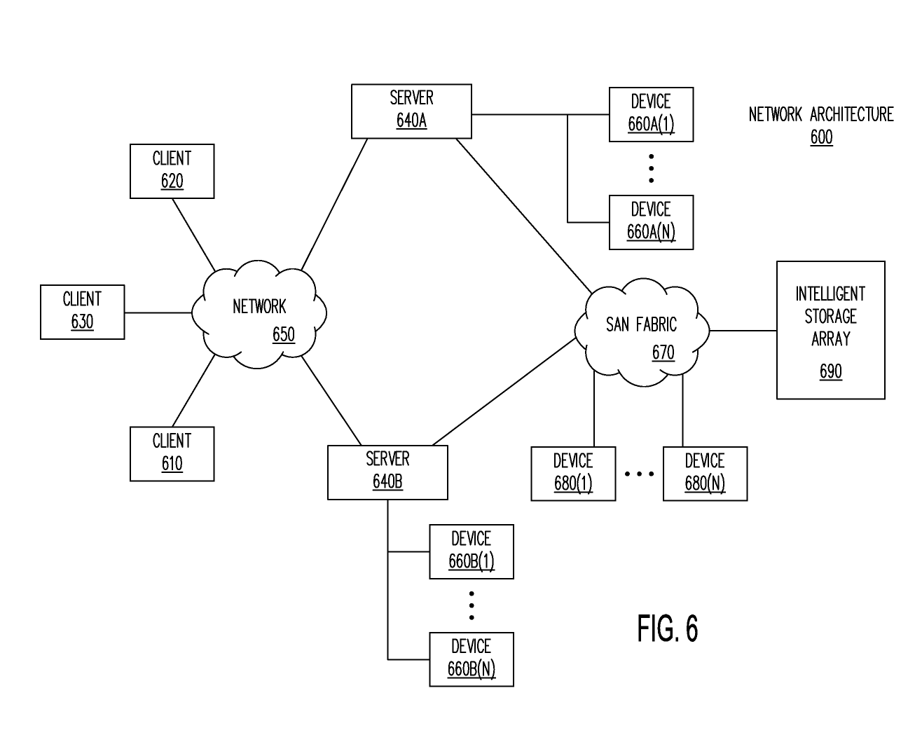

As shown above, the present invention can be implemented using a variety of computer systems and networks. An example of one such computing and network environment is described below with reference to FIGS. 5 and 6.

FIG. 5 depicts a block diagram of a computer system 510 suitable for implementing aspects of the present invention (e.g., servers 140). Computer system 510 includes a bus 512 which interconnects major subsystems of computer system 510, such as a central processor 514, a system memory 517 (typically RAM, but which may also include ROM, flash RAM, or the like), an input/output controller 518, an external audio device, such as a speaker system 520 via an audio output interface 522, an external device, such as a display screen 524 via display adapter 526, serial ports 528 and 530, a keyboard 532 (interfaced with a keyboard controller 533), a storage interface 534, a floppy disk drive 537 operative to receive a floppy disk 538, a host bus adapter (HBA) interface card 535A operative to connect with a Fibre Channel network 590, a host bus adapter (HBA) interface card 535B operative to connect to a SCSI bus 539, and an optical disk drive 540 operative to receive an optical disk 542. Also included are a mouse 546 (or other point-and-click device, coupled to bus 512 via serial port 528), a modem 547 (coupled to bus 512 via serial port 530), and a network interface 548 (coupled directly to bus 512).

Bus 512 allows data communication between central processor 514 and system memory 517, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 510 are generally stored on and accessed via a computer-readable medium, such as a hard disk drive (e.g., fixed disk 544), an optical drive (e.g., optical drive 540), a floppy disk unit 537, or other storage medium. Additionally, applications can be in the form of electronic signals modulated in accordance with the application and data communication technology when accessed via network modem 547 or interface 548.

Storage interface 534, as with the other storage interfaces of computer system 510, can connect to a standard computer-readable medium for storage and/or retrieval of information, such as a fixed disk drive 544. Fixed disk drive 544 may be a part of computer system 510 or may be separate and accessed through other interface systems. Modem 547 may provide a direct connection to a remote server via a telephone link or to the Internet via an internet service provider (ISP). Network interface 548 may provide a direct connection to a remote server via a direct network link to the Internet via a POP (point of presence). Network interface 548 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 5 need not be present to practice the present invention. The devices and subsystems can be interconnected in different ways from that shown in FIG. 5. The operation of a computer system such as that shown in FIG. 5 is readily known in the art and is not discussed in detail in this application. Code to implement the present invention can be stored in computer-readable storage media such as one or more of system memory 517, fixed disk 544, optical disk 542, or floppy disk 538. The operating system provided on computer system 510 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks.

FIG. 6 is a block diagram depicting a network architecture 600 in which client systems 610, 620 and 630, as well as storage servers 640A and 640B (any of which can be implemented using computer system 1010), are coupled to a network 650. In embodiments of the present invention, at least part of network 650 will include wireless connections. Storage server 640A is further depicted as having storage devices 660A(1)-(N) directly attached, and storage server 640B is depicted with storage devices 660B(1)-(N) directly attached. Storage servers 640A and 640B are also connected to a SAN fabric 670, although connection to a storage area network is not required for operation of the invention. SAN fabric 670 supports access to storage devices 680(1)-(N) by storage servers 640A and 640B, and so by client systems 610, 620 and 630 via network 650. Intelligent storage array 690 is also shown as an example of a specific storage device accessible via SAN fabric 670.

With reference to computer system 510, modem 547, network interface 548 or some other method can be used to provide connectivity from each of client computer systems 610, 620 and 630 to network 650. Client systems 610, 620 and 630 are able to access information on storage server 640A or 640B using, for example, a web browser or other client software (not shown). Such a client allows client systems 610, 620 and 630 to access data hosted by storage server 640A or 640B or one of storage devices 660A(1)-(N), 660B(1)-(N), 680(1)-(N) or intelligent storage array 690. FIG. 6 depicts the use of a network such as the Internet for exchanging data, but the present invention is not limited to the Internet or any particular network-based environment.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The foregoing describes embodiments including components contained within other components (e.g., the various elements shown as components of computer system 1010). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

The foregoing detailed description has set forth various embodiments of the present invention via the use of block diagrams, flowcharts, and examples. It will be understood by those within the art that each block diagram component, flowchart step, operation and/or component illustrated by the use of examples can be implemented, individually and/or collectively, by a wide range of hardware, software, firmware, or any combination thereof, including the specialized system illustrated in FIG. 2.

The present invention has been described in the context of fully functional computer systems; however, those skilled in the art will appreciate that the present invention is capable of being distributed as a program product in a variety of forms, and that the present invention applies equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic storage media including floppy disks, hard disks, and tape storage media, semiconductor memory (e.g., FLASH memory, EEPROM, EPROM, ROM, and the like), optical discs (e.g., CD-ROMs, CD-Rs, and DVDs), or other types of memory modules. A storage device used for storing firmware or hardware modules in accordance with an embodiment of the invention can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

The above description is intended to be illustrative of the invention and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the scope of the invention.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

A computer system processes information according to a program and produces resultant output information via I/O devices. A program is a list of instructions such as a particular application program and/or an operating system. A computer program is typically stored internally on computer readable storage medium or transmitted to the computer system via a computer readable transmission medium. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method comprising:
generating data associated with a first sensor event, wherein a hand-held device comprises one or more sensors detecting the sensor e
vent;
transmitting the data to a remote computing node for analysis;
determining whether additional sensor event data is required for the analysis;
in response to said determining, providing the additional sensor event data to the remote computing node;
receiving event results of the analysis from the remote computing node; and
storing the event results in an event data storage in association with an event type identifier.

2. The method of claim 1 further comprising:
generating data associated with a second sensor event;
processing the data associated with the second sensor event;
comparing the processed data with one or more event results stored in the event data storage; and
if the processed data matches an event result, performing one or more actions in response to the associated event type identifier.

3. The method of claim 2 wherein an event result of the one or more event results comprises a signature comprising characteristics of a type of sensor event associated with the event type identifier.

4. The method of claim 3 wherein said processing the data associated with the second sensor event comprises:
generating characteristics of the second sensor event for comparing against signatures stored in the event data storage.

5. The method of claim 3 wherein the signature is generated by vector quantization analysis of the sensor event data as performed by the remote computing node.

6. The method of claim 2 wherein said comparing the processed data with the one or more event results comprises:
performing a means square error analysis.

7. A hand held apparatus comprising:
one or more sensor modules configured to detect a first sensor event and generate data associated with the first sensor event;
a network interface coupled to a network;
a memory; and
processing circuitry, coupled to the one or more sensor modules, the network interface, and the memory, and configured to
if the hand held apparatus is currently in a learning mode,
provide the data associated with the first sensor event to the network interface for transmission to a remote computing node for analysis of sensor event characteristics, and
if additional sensor event data is required for the analysis by the remote computing node, display a request for a user of the hand held apparatus to repeat an action associated with the sensor event,
receive event results of the analysis from the remote computing node via the network interface, and
store the event results in the memory in association with an event type identifier.

8. The hand held apparatus of claim 7 further comprising:
the one or more sensor modules further configured to detect a second sensor event and generate data associated with the second sensor event;
the processing circuitry further configured to
compare identifying characteristics of the second sensor event with one or more event results stored in the memory, and
if the identifying characteristics of the second sensor event match an event result, perform one or more actions in response to the event type identifier associated with the matching event result.

9. The hand held apparatus of claim 8 further comprising:
a signature generator module configured to determine the identifying characteristics of the second sensor event.

10. The hand held apparatus of claim 9 wherein a sensor module of the one or more sensor modules comprises the signature generator module.

11. The hand held apparatus of claim 9 wherein the processor comprises the signature generator module.

12. The hand held apparatus of claim 9 wherein
the signature generator is further configured to determine identifying characteristics of the first sensor event, and
the data associated with the first sensor event comprises the identifying characteristics of the first sensor event.

13. The hand held apparatus of claim 7 wherein a sensor module of the one or more sensor modules further comprises:
one or more sensors configured to generate raw data in response to the first sensor event; and
one or more filters, coupled to the one or more sensors, and configured to filter noise signals from the raw data.

14. The hand held apparatus of claim 13 wherein the one or more sensors comprises:
one or more of an accelerometer, a gyroscope, and an audio sensor.

15. The hand held apparatus of claim 8 wherein the processor is further configured to perform said comparing identifying characteristics using a mean square error calculation.

16. The hand held apparatus of claim 7 wherein the hand held apparatus comprises one of a mobile phone, a smart phone, a tablet computing device, a portable game console, a remote control device, and a digital music player.

17. The hand held apparatus of claim 7 wherein the event results comprise characteristics of a type of event associated with the first sensor event, wherein the characteristics are generated by a vector quantization analysis of the sensor event data performed by the remote computing node.

18. A non-transient computer-readable storage medium storing instructions executable by a processor of a hand-held computing device, the instructions configured to perform steps comprising:
transmitting data associated with a first sensor event to a remote computing node for analysis, wherein the hand-held computing device comprises one or more sensors detecting the sensor event;
determining if additional sensor event data is required for the analysis;
in response to said determining, repeating said transmitting and said determining;
receiving event results of the analysis from the remote computing node; and
storing the event results in an event data storage in association with an event type identifier.

19. The computer-readable storage medium of claim 18 comprising further instructions executable by the processor and configured to perform steps comprising:
comparing data associated with a second sensor event with one or more event results stored in the event data storage; and
if the data associated with the second sensor event matches an event result, performing one or more actions in response to the associated event type identifier.

20. The computer-readable storage medium of claim 19 comprising further instructions executable by the processor and configured to perform steps comprising:
generating characteristics of the second sensor event for comparing against the one or more event results stored in the event data storage, wherein
the one or more event results comprise characteristics of a type of event associated with the first sensor event, and
the characteristics are generated by a vector quantization analysis of the sensor event data performed by the remote computing node.
